(19) United States
(12) Patent Application Publication
(10) Pub. No.: US 2004/0054494 A1
(43) Pub. Date: Mar. 18, 2004

(54) Flow control method for maximizing resource utilization of a remote system

(76) Inventor: Ayman M. El-Khashab, Austin, TX (US)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/660,848

(22) Filed: Sep. 12, 2003

Related U.S. Application Data
(60) Provisional application No. 60/410,155, filed on Sep. 12, 2002.

(51) Int. Cl. G06M 11/04

(52) U.S. Cl. 702/127

(57) ABSTRACT

A failsafe feedback method between a data processing system and a control system maximizes resource utilization and prevents data overrun of the data processing system. The method acknowledges status messages from a processing system while other status messages may still be in communication from the processing system. The status messages provide the control system with information about how much more data the processing system can accept. The control system then uses this information to determine whether to continue to send data.

### CROSS REFERENCE TO RELATED APPLICATION

This application claims priority from U.S. Provisional Patent Application Serial No. 60/410,155, filed Sep. 12, 2002, and entitled “A Flow Control Algorithm for Maximizing Resource Utilization on a Remote System.”

### TECHNICAL FIELD OF THE INVENTION

The present invention relates in general to the field of data processing and more specifically to a flow control method for maximizing the resource utilization of a remote system.

### BACKGROUND OF THE INVENTION

Some data processing systems include two or more separate systems. Many data processing systems include a first system that controls the generation of data and a second system for processing the generated data. The second system, however, typically has a limited amount of data processing resources.

Current data processing systems, and in particular data processing system for processing image data, have limited feedback between the control system and the image processing system. Often, the control system has limited knowledge of whether resources are available on the image processing system. If the control system assumes that there are no resources available, then the unused processing resources are essentially wasted. If instead the control system assumes that the processing system has resources available, then data may be sent when all of the resources of the processing system are exhausted.

One method of optimizing remote resource utilization while preventing overruns utilizes a high and low “water mark”. This method sets a high water mark on the number of resources consumed. Once that limit is reached, the control system does not generate any more data until the resources consumed reaches the low water mark. While this type of algorithm is easy to implement and understand, it has a number of drawbacks. One problem with this algorithm is that at high data rates, it is possible to overrun the resources on the processing system. At low data rates, resources beyond the high water mark are never utilized. Also it is often difficult to determine what the high and low settings should be.

Another type of algorithm used to manage the generation of data is an adaptive algorithm that attempts to adjust resource utilization based on data rates. This type of algorithms can work in systems with a constant data rate. However, in systems in which the data rate is not constant over short periods of time, the adaptive algorithm may not accurately predict the available resources of the processing system.

### SUMMARY OF THE INVENTION

Therefore a need has arisen for a data processing system for managing resource utilization of a remote data processing system.

A further need has arisen for a method of managing resource utilization of remote data processing resources in systems have a variable data rate.

In accordance with teachings of the present disclosure, a system and method are described for a failsafe feedback mechanism between a data processing system and a control system that maximizes resource utilization and prevents data overrun of the data processing system. The present invention utilizes a method that acknowledges status messages from a processing system while other status messages may still be in transit from the processing system. The present invention provides the control system with information about how much more data the processing system can accept. The control system then uses this information to determine whether to continue to send data.

In one aspect a data acquisition system includes a control system connected to a data capture module that is connected with a processing system. The control system can send trigger commands to the data capture module and each trigger command has a corresponding incremental trigger number. The control system includes a trigger counter for storing the trigger number of the most recently sent trigger command. The data capture module records an output image that corresponds with an associated target that is then sent to the processing system along with the trigger number. The processing system is made up of multiple discreet processing resources that may each process an output image. The processing system periodically sends a status message to the control system that includes, 1) a message ID, 2) the last trigger number received by the processing system and 3) the number of available processing resources. The control system then limits the number of new trigger commands sent to the data capture module based on the status message that has the highest message ID and the trigger counter.

In another aspect a data acquisition management system is described that includes a first system in communication with a second system through a one-way communication channel. The first system selectively triggers the acquisition of an output file to be sent to the second system for processing. Each trigger also includes a corresponding incremental trigger number recorded by a trigger counter. The second system includes multiple discreet processing resources, each able to process an output file received from the first system. The second system also periodically sends a status message to the first system via a network, where each status message includes a message ID, the last trigger number received by the second system, and the number of available processing resources. The first system then limits the acquisition of output files based on the status message having the highest message ID and the trigger counter.

In yet another aspect a method of managing a data acquisition system includes sending a trigger command with a corresponding incremental trigger number from a control system to a data capture module. The trigger number of the most recently sent trigger command is recorded in a trigger counter and an output image corresponding to a target associated with the data capture module is sent to a processing system in response to the trigger command. The output image and the corresponding trigger number are then sent to a processing system that has multiple discreet processing resources that may each process an output image. A status message including a message ID, the last trigger number received by the processing system, and the number of available processing resources is then periodically sent from the processing system to the control system. The method then uses the status message having the highest message ID and the trigger counter to limit the number of trigger commands sent to the data capture module.

The present invention includes a number of important technical advantages. One technical advantage of the present disclosure includes using information in a status message and a trigger counter to limit the number of trigger commands sent to a data capture module. This allows a control system to effectively utilize and manage the flow a data sent to a remote processing system. Additional advantages of the present invention are described in the description, figure and claims below.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a depiction of a data acquisition system according to teachings of the present invention;

FIG. 2 is a status message according to the present invention;

FIG. 3 is a diagram of a data acquisition system according to teachings of the present invention; and

FIG. 4 shows a demonstrative series of status messages received by a control system.

### DETAILED DESCRIPTION

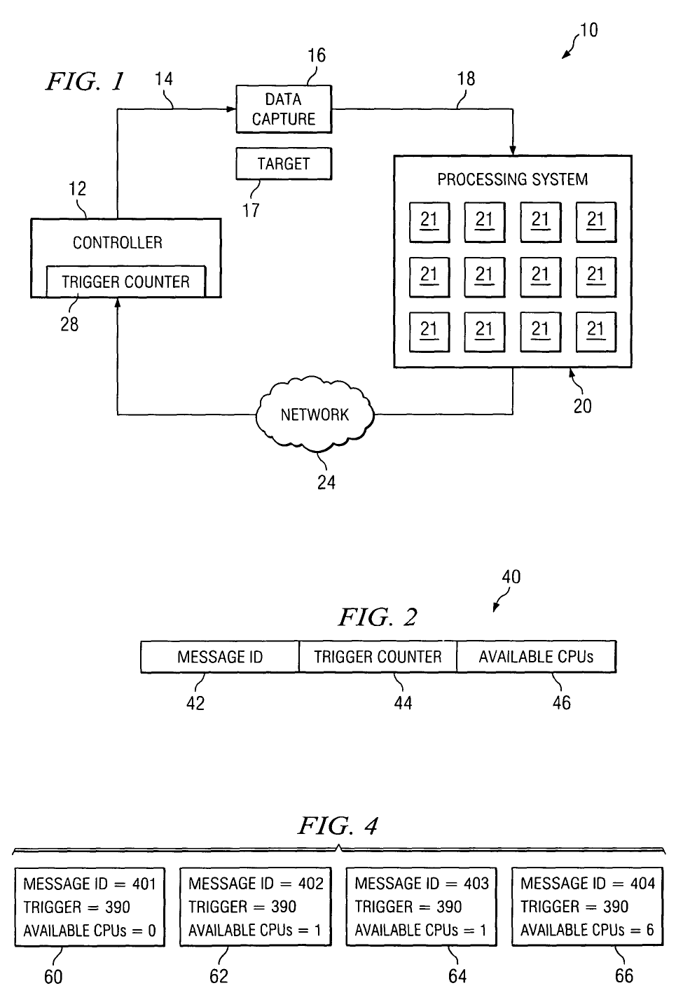

Preferred embodiments and their advantages are best understood by reference to FIGS. 1 through 4, wherein like numbers are used to indicate like and corresponding parts.

Now referring to FIG. 1, a data acquisition system, depicted generally at 10 includes a controller 12, data capture module 16, and processing system 20. Controller 12 is connected with data capture module 16 via connection 14. Data capture module 16 is connected with processing system 20 via connection 18. In the present preferred embodiment, connections 14 and 18 are hard wired, one-way communication channels allowing communication to flow from controller 12 to processing system 20.

Controller 12 operates to send control instructions to data capture module 16. Controller 12 sends trigger commands to data capture module 16 to initiate the acquisition of data related to an associated target 17. Each trigger command sent by controller 12 also has an associated incremental trigger number assigned thereto. This incremental trigger number, which may also be referred to as a trigger serial number, associates a unique identifier with each trigger command sent to data capture module 16. Controller 12 includes trigger counter 28 which operates to record the trigger number of the trigger command most recently sent to data capture module 16.

Data capture module 16 may comprise any data capture system used to acquire data corresponding to an associated target 17. In the present embodiment, data capture module 16 preferably captures image data associated with target 17. In one particular preferred embodiment, data capture module 16 comprises a direct-to-digital holographic imaging system as described in U.S. Pat. No. 6,078,392 entitled Direct-to-Digital Holography and Holovision, U.S. Pat. No. 6,525,821 entitled Acquisition and Replay Systems for Direct to Digital Holography and Holovision, U.S. patent application Ser. No. 09/949,266 entitled System and Method for Correlated Noise Removal in Complex Imaging Systems and U.S. patent application Ser. No. 09/949,423 entitled, System and Method for Registering Complex Images, all of which are incorporated herein by reference.

In response to receiving a trigger command from controller 12, data capture module 16 acquires an output file of data related to target 17. In a preferred embodiment, the output file comprises an image file. In a particular preferred embodiment, the output file is an image file containing holographic image data (including both phase data and amplitude data). The output file, along with the trigger number of the trigger command that initiated the acquisition of the output file is then sent to image processing system 20 via communication channel 18.

Processing system 20 includes multiple discreet processing resources 21. In the present embodiment processing resources 21 are CPUs which may each process an output file sent from data capture module 16. Processing system 20 periodically generates a status message (as described in FIG. 2, below) that is sent to controller 12 via network connection 24. In some embodiments, processing system 20 generates a status message each time a processing resource completes the processing of an output file and becomes available to process a new output file. In another embodiment, a status message is sent out after a selected period of time such as, for example, five seconds. In yet another embodiment, processing system 20 may generate and transmit a status message to control system 12 after a processing resource becomes available or if no status message has been sent within a selected time period. In some embodiments control system 12 may generate a status message after any change after the expiration of a selected period, a change in processor availability, or a new trigger is received. Processing system may further generate and receive a status message any time a new output file and trigger number is received.

Now referring to FIG. 2, a depiction of a status message 40 is shown. Status message 40 includes message identifier 42, trigger number 44, and available processing resource number 46. Message identifier 42 is preferably an incrementing serial number that uniquely identifies each status message. Trigger number 44, which identifies the last trigger number received by processing system 20 and is used to synchronize systems amongst one another, and to determine the number of resources available at the time the message was generated.

Control system 12 uses status messages received from processing system 20 to match data rates between data capture system 16 with the processing availability of processing system 20. This technique particularly is useful over asymmetric links between the systems with an arbitrary communication delay. In particular, the one-way communication channels 14 and 18 are typically faster and more reliable than communications sent via network 24. Controller is preferably able to use status messages to both maximize the data throughput while preventing data overruns on the processing system 20. The technique, which may preferably implemented as an algorithm within controller 12, is failsafe in that control system 12 can determine the current state of processing system 20 in the event that a status message is lost, out of order, or arrives after a significant time delay. The data flow management technique also operates independent of system data rates because it does not attempt to determine the data rate of the any part of system 10.

In operation, Controller 12 initially assumes that there is at least one available processing resource 21 on processing system 20. The data capture module is triggered and this trigger is assigned a trigger number or other unique identifier, in this case 0. An outpost file is then captured and sent to processing system 20 which begins to process the output file. At this point, the number of available processing resources is decremented by one. A status message 40 is then created and sent to control system 12. When control system 12 receives the status message, it determines, based on the information in the message, the number of processing resources 21 available on processing system 20. Since status message 40 contains (in terms of trigger number 44) the time of its creation, control system 12 can determine the difference between the trigger number 44 and trigger counter 28. This result is the number of consumed CPUs beyond what is represented in status message 40. Since status message 40 contains a unique, incrementing message ID 42, if a status message is lost, control system 12 need only wait for a status message with a higher message ID 42 than the last message received. In the event a message arrives out of order, System A can ignore any message with a lower message ID than that of a status message previously received by control system 12. System B also preferably sends a status message 40 per a selected period if all processing resources 21 are exhausted or whenever there is a change in the number of available processing resources 21.

One advantage of this system is that it allows optimal use of the processing resources 21 of processing system 20 regardless of data rates or dynamic changes in data rates, communication latency or reliability, or the number of available resources. The only design tradeoff is that to optimally use all processing resources 21, status messages must arrive at controller 12 periodically before all processing resources 21 are exhausted. This does not result in a failure in the method, only less than optimal resource utilization. Additionally, in one particular embodiment control system 12 must make an initial assumption of having at least one available processing resource 21 before it receives the first status message from processing system 20.

Experimentally, the system described has performed correctly at both low and high data rates. Further, the number of processing resources 21 has not affected performance. Despite the latency in the message transmission through network 24, processing system 20 is often using all of its resources and as soon as one becomes available, control system 12 sends a trigger to allow the newly available resource to be utilized. Compared to previous algorithms, this method does not overrun processing system 20 or under utilize processing resources 21. In addition, this method has continued to perform as designed under constantly changing data rates.

This method has further uses in applications where two systems must synchronize in real time to maximize resource usage while avoiding resource exhaustion. The principle is the ability of the message receiver to combine data in the message with its own data to deduce the state of the message sender. One embodiment is in a manufacturing load distribution system where a single producer provides data to many consumers. If the data takes a non-deterministic time to process, the producer cannot cycle through the consumers. Instead, each consumer can periodically send messages detailing its current state at some time. The producer can then coalesce the data and choose the best candidate consumer.

The present invention also allows a user to purchase only the needed number of CPUs for processing system 20. The method inherently adjusts to changing data rates (for instance if a faster data capture module becomes available), or an increase in the number of discreet processing resources 21 within processing system 20. Ultimately, the ability to maximize processing resource sage and throughput results in a reduced cost and an overall speed improvement in data acquisition system 10, Lastly, the present invention eliminates the need to handle error conditions that arise when images are captured too quickly for processing. Ultimately, the invention ensures that a data overrun error will not occur because the control system 12 can determine the resource availability of processing system 20, even if the knowledge is not current.

In one particular embodiment, controller 12 and data capture module 16 may be effectively combined into a first system. This first system may then communicate output files to a second system, in this embodiment, processing system 20.

Additionally, the system allows multiple status messages to be “in-flight” simultaneously and permits both lost status messages and out of order statue messages. In the event all status messages are lost, the system continuously, sends new unique messages periodically until the communication channel (such as network 24) is available.

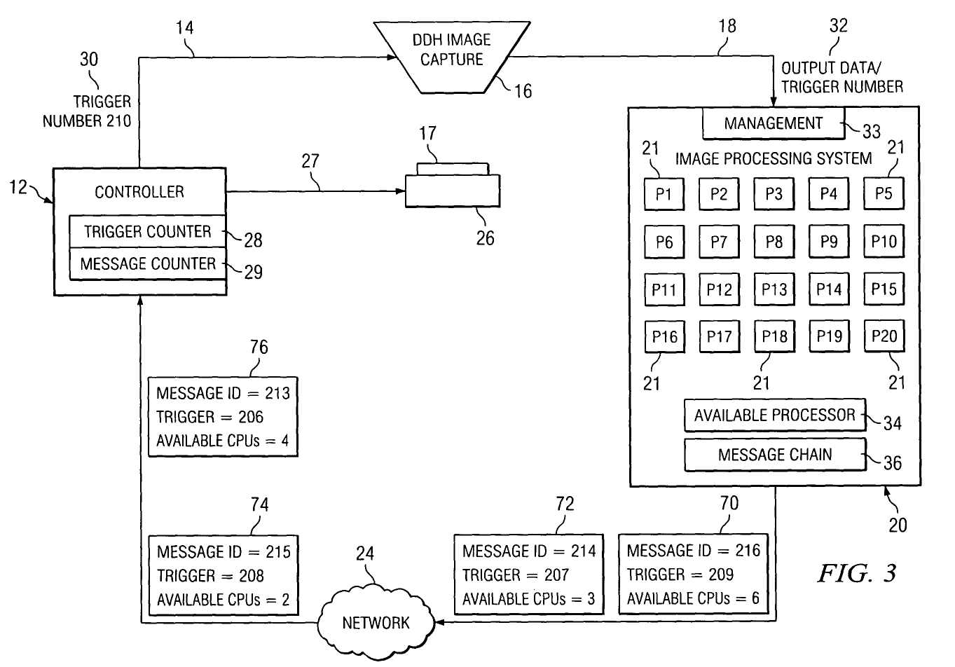

Now referring to FIG. 3, a demonstrative diagram of data acquisition system 10 is shown. In the present embodiment, data acquisition system includes controller 12 connected with data capture module 16 and also with positioning system 26. Positioning system 26 may selectively position an associated target 17 with respect to data capture module 16. Target 17 may comprise a semiconductor device, a photomask, a reticle, or any other suitable target. Controller 12 selectively sends trigger commands 30 to data capture module 16 via communication channel 14. In the present embodiment controller includes trigger counter 28 and status message counter 29. Status message counter 29 preferably records the highest status message number received from image processing system 20.

Date capture module 16 acquires data related to associate target 17 in response trigger command 30. The acquired data, in the form of output file 32, is then sent to processing system 20. In the present embodiment, processing system 20 includes management module 33, available processor module 34 and status message generator 36. In alternate embodiments, the function of management module 33, available processor module 34 and status message generator 36 may be performed by one or more of discreet processing resources 21. Management module 33 operates to receive incoming output files 32 and distribute them to an available processing resource 21. Available processor module 34 operates to determine the number of available discreet processing resources 21 and status message generator constructs and sends out status messages 40.

It should be noted that the components depicted such as trigger counter 28, message counter 29, available processor module 34, and status message generator 36 represent functional elements that are reasonably self-contained so that each can be designed, constructed, or updated substantially independently of the others. In other embodiments, however, it should be understood that the components may be implemented as hardware, software, or combinations of hardware and software for providing the functionality described and illustrated herein.

The present embodiment demonstrates four status messages 70, 72, 74, and 76 being sent from processing system 20 to controller 12. In this diagram, control system 12 last known state of processing system 20 is contained in status message 212 (not expressly shown). At that time, processing system 20 indicated it had received trigger number 205 and had 5 resources available. Control system 12 then updates the count of available processing resources on processing system 20 by using the local trigger counter 28 (trigger command 30 having a trigger number of 210 as shown).

The computation performed by controller 12 to determine the number of available processing resources is:

(MsgTriggerNumber+MsgAvailableCount)−CurrentTrigger

Control system 12 determines there are no more resources available, (205+5)−210=0, and will not send any additional trigger commands 30 until a status message with a higher MsgID 42 arrives and increases the number of available processing resources 21.

Next, control system 12 will receive status message 76. After performing the calculation above (206+4)−210+0, control system 12 will continue to refrain from sending additional trigger commands to data capture module 16. Next, control system will receive status message 74 having a message id of 15. After performing the calculation above (208+2)−210=0, control system 12 will continue to refrain from sending additional trigger commands to data capture module 16. Next, controller 12 will receive status message 72 having a message id of 214; this status message will be ignored because a message with a higher message ID (message ID 215 in status message 74) has already been received by controller 12. However, status message 70 having a message ID of 216 will allow control system 12 to send up to five additional trigger commands 30 to data capture module 16 after performing the calculation above (209+6)−210=5.

In the event that each of the discreet process resources 21 on processing system 20 are completely exhausted, processing system 20 will send a new status message with a new serial number (MsgID) and the last trigger count whenever there is a change in the number of available processing resources 21. Further, periodically messages are sent in the event that the communication channel (network 24) becomes unreliable.

Now referring to FIG. 4, a series of demonstrative status messages 60, 62, 64, and 66 are shown. When status message 60 having message ID 401 is received by control system 12, it will take no action because there are no resources on processing system 20 available. As soon as a processing resource 21 becomes available, processing system sends status message 62 that has message ID 402 to indicate this change of state. However, in this example, after some time, control system 12 has not issued any new trigger commands 30. Processing system 20 System B maintains a timer preferably issues a new message after the expiration of a selected period. Status message 64 having message ID 403 is issued by processing system 20 indicating the same state as message 402. Later, as six processing resources become available, processing system 20 issues a new status message 66 having message ID 404 to indicate this state.

Although the disclosed embodiments have been described in detail, it should be understood that various changes, substitutions and alterations can be made to the embodiments without departing from their spirit and scope.

What is claimed is:

1. A data acquisition system comprising:
a control system in communication with a data capture module, the data capture module in communication with a processing system;
the control system operable to selectively send trigger commands to the data capture module, each trigger command having a corresponding incremental trigger number;
the control system having a trigger counter for storing the trigger number of the most recently sent trigger command;
the data capture module operable to generate an output image corresponding to an associated target and send the output image and the corresponding trigger number to the processing system in response to the trigger command;
the processing system comprising a plurality of discreet processing resources, each processing resource operable to process an output image;
the processing system operable to periodically send a status message to the control system, the status message comprising a message ID, the last trigger number received by the processing system, and the number of available processing resources; and
the control system operable to limit the number of new trigger commands sent to the data capture module based on the status message having the highest message ID and the trigger counter.

2. The data acquisition system of claim 1 wherein the data capture module comprises a CCD camera.

3. The data acquisition system of claim 1 further comprising:
the control system connected with the data capture model via a one-way communication channel;
the data capture module connected with the processing system through a one-way communication channel; and
the processing system connected with the control system through a network.

4. The data acquisition system of claim 3 further comprising the processing system in communication with the controller via an Ethernet connection.

5. The data acquisition system of claim 1 further comprising the control system in communication with a positioning system, the positioning system operable to selectively position the associated target with respect to the data capture module.

6. The data acquisition system of claim 1 further comprising the data capture module operable to transmit digital holographic image data to the processing system.

7. The data acquisition system of claim 1 wherein the processing system comprises at least ten processors.

8. The data acquisition system of claim 1 control system operable to limit the number of trigger commands by:
selecting the status message having the highest message ID;
adding the number of available processors in the selected status message and the trigger number of the selected status message;
subtracting the trigger number stored in the trigger counter; and
using the result to limit the number of new trigger command sent to the data capture module.

9. The data acquisition system of claim 1 further comprising the controller having a message counter for recording the message ID of the highest message ID received by the controller, the controller operable to disregard received status messages having a lower message ID than the message ID stored in the message counter.

10. The data acquisition system of claim 1 further comprising the image processing system operable to generate a status message when a processing resource completes the processing of an output image.

11. The data acquisition system of claim 1 further comprising the image processing system having a trigger counter operable to record the last trigger number received from the date capture module.

12. The data acquisition system of claim 1 further comprising the image processing system having an available processor module for determining the number of available processors within the image processing system.

13. A data acquisition management system comprising:
a first system in communication with a second system through a one-way communication channel;
the first system operable to selectively trigger the acquisition of an output file to be sent to the second system for processing, each trigger having a corresponding incremental trigger number;
the first system having a trigger counter for storing the trigger number of the most recently sent trigger command;
the second system comprising a plurality of discreet processing resources, each processing resource operable to process an output file received from the first system;
the second system operable to periodically send a status message to the first system via a network, the status message comprising a message ID, the last trigger number received by the second system, and the number of available processing resources; and
the first system operable to limit the acquisition of output files based on the status message having the highest message ID and the trigger counter.

14. The data acquisition management system of claim 13 further comprising a CCD camera operable to capture holographic image data corresponding to an associated target.

15. The data acquisition management system of claim 13 further comprising the first system operable to limit the number of output files by:
selecting the status message having the highest message ID;
adding the number of available processors in the selected status message and the trigger number of the selected status message;
subtracting the trigger number stored in the trigger counter; and
using the result to limit the acquisition of data by the first system.

16. The data acquisition system of claim 13 further comprising the first system having a message counter for recording the message ID of the highest message ID received, the first system operable to disregard received status messages having a lower message ID than the message ID stored in the message counter.

17. A method of managing a data acquisition system comprising:
sending a trigger command from a control system to a data capture module, the trigger command having a corresponding incremental trigger number;
recording the trigger number of the most recently sent trigger command in a trigger counter;
generating an output image corresponding to a target associated with the data capture module in response to the trigger command;
sending the output image and the corresponding trigger number to a processing system have a plurality of discreet processing resources, each processing resource operable to process an output image;
periodically sending a status message from the processing system to the control system, the status message comprising a message ID, the last trigger number received by the processing system, and the number of available processing resources; and
limiting the new trigger commands sent to the data capture module based on the status message having the highest message ID and the trigger counter.

18. The method of claim 17 wherein limiting the new trigger commands further comprises:
selecting the status message having the highest message ID;
adding the number of available processors in the selected status message and the trigger number of the selected status message;
subtracting the trigger number stored in the trigger counter; and
using the result to limit the number of trigger commands sent to the data acquisition module by the control system.
